(19) United States
(12) Patent Application Publication
(10) Pub. No.: US 2001/0048179 A1
(43) Pub. Date: Dec. 6, 2001

(54) Extrusion aid combination

(76) Inventors: Charles W. Stewart, Newark, DE (US); Stuart K. Randa, Wilmington, DE (US); Savvas G. Hatzikiriakos, Surrey (CA); Evgueni E. Rozenbaoum, Arcadia, CA (US); Marlin D. Buckmaster, Vienna, WV (US)

Correspondence Address: E I DU PONT DE NEMOURS AND COMPANY, LEGAL DEPARTMENT - PATENTS, 1007 MARKET STREET, WILMINGTON, DE, 19898, US

(21) Appl. No.: 09/740,285

(22) Filed: Dec. 19, 2000

Related U.S. Application Data
(60) Provisional application No. 60/171,555, filed on Dec. 22, 1999.

(51) Int. Cl. B29C 47/00; C08L 23/06; C08L 23/12; C08L 27/18; C08K 3/38

(52) U.S. Cl. 264/211; 524/404; 524/544; 524/584; 524/586; 525/199; 525/240

(57) ABSTRACT

The combination of fluoropolymer processing aid with foam cell nucleating agent gives a combined processing aid that is far superior to either individually when used in the extrusion of melt processible polymers.

### FIELD OF THE INVENTION

This invention is in the field of extrusion aids for polymer processing.

### BACKGROUND OF THE INVENTION

In the extrusion of thermoplastics to make articles such as wire coatings and films, it is desirable that the articles have smooth surfaces. It is also desirable for extrusion rates to be as high as possible to make the most efficient use of the processing machinery and thereby reduce capital costs. However, as extrusion rate is increased, a point is reached at which surface begins to roughen, developing first a frosty finish, and, if the extrusion rate increases further, more severe roughening, described as “sharkskin”, and finally “melt fracture”. These phenomena and other aspects of surface deterioration at high extrusion rates are discussed in Melt Rheology and it Role in Plastics Processing, J. M. Dealy and K. F. Wissbrun, Van Nostrand Reinhold, N.Y., 1990, pp. 336-341. To delay the onset of surface deterioration and thereby permit extrusion at higher rates without loss of surface smoothness, additives called processing aids or extrusion aids have been developed.

Fluoropolymers are useful processing aids in the extrusion of hydrocarbon polymers, of which the polyolefins polyethylene and polypropylene are commercially important examples. Examples of fluoropolymer additives are found in U.S. Pat. Nos. 3,125,547, 4,904,735, and 5,707,569.

Addition of foam cell nucleating agents to melt processible polymers improves the surface smoothness of extrudates of these polymers and permits increased extrusion rates without deterioration of surface properties (U.S. Pat. No. 5,688,457).

New processing aids are needed to permit further improvements in extrusion rates and higher productivity of plastics processing equipment.

### SUMMARY OF THE INVENTION

It has been discovered that combining fluoropolymer processing aid with foam cell nucleating agent, such as boron nitride (BN), gives a new processing aid that delays the onset of surface deterioration to enable extrusion rates greater than those achievable with the use of either ingredient alone.

In one embodiment, the invention is a melt processible composition comprising a melt processible polymer, about 0.001 to about 5 wt. % foam cell nucleating agent, and about 0.001 to about 5 wt. % fluoropolymer processing aid.

In a second embodiment, the invention is the process of extrusion of a melt processible composition comprising melt processible polymer, about 0.001 to about 5 wt. % foam cell nucleating agent, and about 0.001 to about 5 wt. % fluoropolymer processing aid.

### BRIEF DESCRIPTION OF THE DRAWINGS

FIG. 1 is a side view in cross-section of the extrusion die.

FIG. 2 is a graph comparing the effect of boron nitride and Viton® fluoroelastomer on the flow curves of the metallocene polyethylene Exceed® 116 obtained with the extrusion die.

FIG. 3 is a graph comparing the effect of boron nitride and Teflon® APA-II nonelastomeric processing aid on the flow curves of the metallocene polyethylene Exact® 3128 obtained with the extrusion die.

FIG. 4 is a graph comparing the effect of boron nitride and Teflon® APA-II nonelastomeric processing aid on the flow curves of the metallocene linear low density polyethylene Exceed® 116 obtained with the extrusion die.

### DETAILED DESCRIPTION OF THE INVENTION

Melt processible polymers of this invention include any polymer that may be extruded at temperatures below its decomposition temperature. Important melt processible polymers are polyethylene and polypropylene, collectively known as polyolefins. Examples of specific polyolefins are polypropylene, e.g. isotactic polypropylene, linear polyethylenes such as high density polyethylenes (HDPE), linear low density polyethylenes (LLDPE), e.g. having a specific gravity of 0.89 to 0.92. The relatively new linear low density polyethylenes made with metallocene catalysts such as the INSITE® catalyst technology of Dow Chemical Company and the polymers marketed under the EXACT® and EXCEED® trademarks by the Exxon Mobil Corporation can also benefit from the present invention. These resins are generically called metallocene linear low density polyethylene (mLLDPE). The thermoplastic polymer can be a single polymer or a blend of polymers.

Fluoropolymers effective as processing aids according to this invention include Viton® fluoroelastomers and Viton Freeflow® fluoropolymers and fluoropolymer alloys, available from DuPont Dow Elastomers L. L. C., Elkton Md. USA; Dynamar® polymer processing additives, available from Dyneon LLC, Oakdale Minn. USA; Kynar Flex® processing aid, available from Atofina Chemicals, Philadelphia Pa. USA; and Tecnoflon®, available from Ausimont USA Inc., Thorofare N.J. USA. These fluoroelastomer processing aids are usually polymers of hexafluoropropylene and vinylidene fluoride (HFP/VF2), or of tetrafluoroethylene, hexafluoropropylene, and vinylidene fluoride (THV). Also effective are nonelastomeric processing aids such as Teflon® APA-II, a polymer of tetrafluoroethylene and hexafluoropropylene described in Example 2 of U.S. Pat. No. 5,734,683. This class of materials is identified herein as fluoropolymer processing aids.

Foam cell nucleating agents effective in this invention are inorganic or organic materials. They are thermally stable under the conditions of extrusion, that is, they do not liberate anything that can cause bubble formation. They are solid under the extrusion conditions, although they may at least partially dissolve in the molten polymer during extrusion.

Examples of inorganic foam cell nucleating agents include boron nitride, talc, metal oxides such as MgO, Al₂O₃, and SiO₂, calcium carbonate, and calcium, zinc, sodium or potassium tetraborates. Boron nitride is a preferred foam cell nucleating agent in extrusion according to this invention. The type of boron nitride used is that which is commonly known as hexagonal boron nitride or graphite-like boron nitride, and is available from Carborundum Corporation, Amherst N.Y. USA.

Examples of organic foam cell nucleating agents include low molecular weight polytetrafluoroethylene, often called PTFE micropowder, the low molecular weight being characterized by a melt viscosity of 1·10³ to 1·10⁵ Pa•s at 372° C. Additional examples of nucleating agents include the fluorinated sulfonic and phosphonic acids and salts disclosed in U.S. Pat. No. 5,023,279, such as Telomer® B sulfonic acid having the formula F(CF₂)ₙCH₂CH₂SO₃H, where n is an integer from 6 through 12. Particular types of Telomer® B are identified by the predominant value of the integer “n”. For example, BaS-10 is the barium salt of the sulfonic acid in which n=10 in the predominant chain length present. Additional types include BaS-8, ZrS-10, CrS-10, FeS-10, CeS-10, and CaS-10.

Hydrocarbon sulfonic or phosphonic acids are also effective in lower melting thermoplastic polymers, such as polyethylene and polypropylene. The salts of these are identified in a similar way. For example, BaS-3H is barium propane sulfonate and KS-1H is potassium methane sulfonate.

The eight-carbon perfluorinated sulfonic acid available as Fluororad® FC-95, can also be used.

At least one foam cell nucleating agent and one fluoropolymer processing aid is used according to this invention, but more than one of either or both may be used. They can be added to the polymer in the extruder or can be dry-mixed therewith prior to extrusion, the goal in either case being to obtain a uniform distribution of the nucleating agent within the molten polymer at least just prior to extrusion. The nucleating agent can be added to the polymer undiluted or the foam cell nucleating agent may be in the form of a concentrate of the foam cell nucleating agent in polymer which is the same as or is compatible with the polymer to be extruded, i.e. the host polymer. The concentrate may have ten or more times the concentration of fluoropolymer and foam cell nucleating agent than will be present in the extruded polymer to make whatever product is desired. In extrusion, the concentrate may be added to the melt processible polymer, which is usually in pellet or cube form, in an amount such that the final concentration of the processing aids in the polymer will be within the desired range. The melt processible polymer and concentrate are mixed by shaking, tumbling, or other means to ensure even distribution of the concentrate throughout the polymer. Alternatively, the concentrate may be metered into the extruder with the melt processible polymer pellets at a rate that will give the desired concentration of processing aid in the polymer.

The extrusion process of the present invention produces an unfoamed extrudate and unfoamed articles such as wire insulation, wire coating, tubing, film, sheet, and rods obtained from the extrudate. By extrusion of an unfoamed polymer in the process of the present invention is meant that neither the extrudate nor its articles are foamed. The extrudate and articles obtained from the extrudate may have a small percentage of voids resulting from air or other gas entering the extruder with the polymer feed, but such articles will nevertheless contain no more than 5% voids and preferably less, e.g. less than 3% voids, which would not be considered as a foamed extrudate or foamed article.

The concentrations of fluoropolymer processing aid and foam cell nucleating agent useful as combined processing aid are independently 0.001 weight % (wt. %) to 5 wt. %, preferably independently about 0.001 to about 1 wt. %, and more preferably independently about 0.01 wt. % to about 1 wt. %. In the concentrate, the concentrations of fluoropolymer and foam cell nucleating agent useful as combined processing aid may be independently about 0.01 wt. % to about 10 wt. %, so as to accommodate dilution or “let down” of the concentrate to achieve concentration levels of the processing aid components to within the useful concentration ranges disclosed above. Weight % is based on the total weight of polymer plus fluoropolymer processing aid and foam cell nucleating agent.

### TEST METHODS

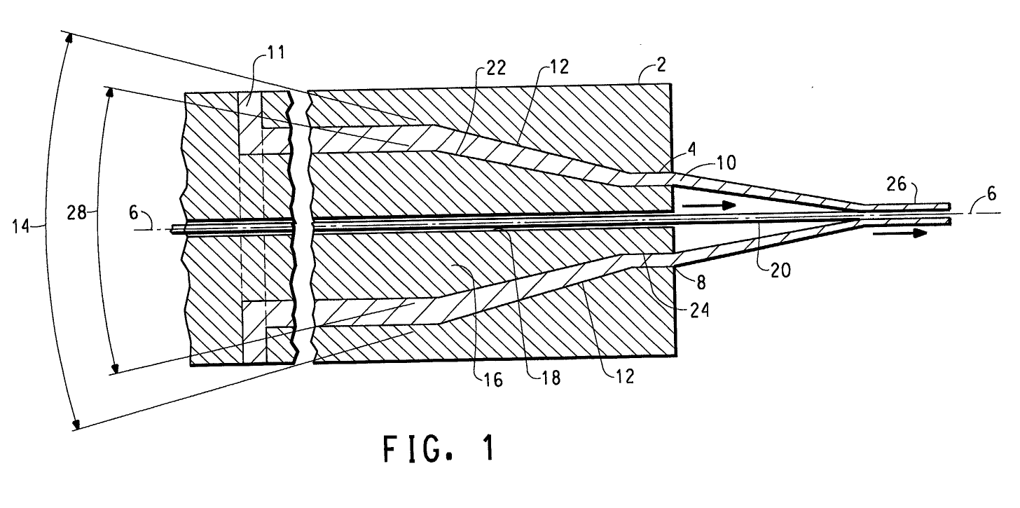

The rheometer used is the standard Instron piston-driven constant-speed capillary unit with a standard barrel of 0.955 cm diameter and an interchangeable nonstandard barrel of 2.5 cm diameter. Two types of dies are available, circular dies having a 90° entrance angle (used with the standard barrel), and an annular crosshead die attached to the nonstandard barrel of the rheometer in order to mimic the wire coating process (see FIG. 1). The crosshead die is a Nokia Maillefer 4/6 that includes dies and tips of various diameters (the “tip” is the wire guide) with equal entry cone angles of 60° and the die land length of 7.62 mm. In the examples reported herein the inner diameter of the die used is 3.1 mm, and the outer diameter of the tip used is 1.53 mm (the tip has an inner diameter also, but that dimension is not critical). The molten polymer enters the die 2 via port 11 and is forced around the wire guide 16 towards the die orifice 8. The wire guide serves as a mandrel for the molten polymer, giving the extrudate 10 a tubular shape. The die passage 4 forms the exterior surface of the tubular shape, and the exterior surface of the cylindrical extension 24 forms the interior surface of the tubular shape. When wire is used, the greater speed of the wire compared to the polymer extrusion rate causes the polymer coming into contact with the wire at a point remote from the orifice 8 to draw down to a thinner cross-section, forming a thin polymer coating 26 on the wire. This is a melt draw-down extrusion process with draw down ratio (DDR), which is the ratio of die orifice area to cross-sectional area of the polymer insulation, of at least 5:1. However, in the present study the pressure extrusion makes no use of wire and therefore DDR is irrelevant.

The condition of the surface of the extrudate is determined by visual observation. Under acceptable extrusion conditions, the surface of the extrudate is glossy and smooth. Deterioration of the surface is observed as loss of gloss and then the development of a rougher surface texture. The shear rate at which surface deterioration appears is defined here as the critical shear rate.

Results are presented graphically as apparent shear stress versus apparent shear rate. These are standard Theological terms. Shear stress is a measure of the force associated with a corresponding shear rate. Shear rate is related to extrusion rate. Shear stress increases with shear rate, as would be expected: it takes greater force to move the polymer at a faster rate through the die. The shear stress/shear rate curves do not give information on the appearance of deterioration of surface smoothness or the development of sharkskin or other malformations of the extrudate. Therefore, onset of surface deterioration is indicated with labels on the graphs.

### EXAMPLE 1

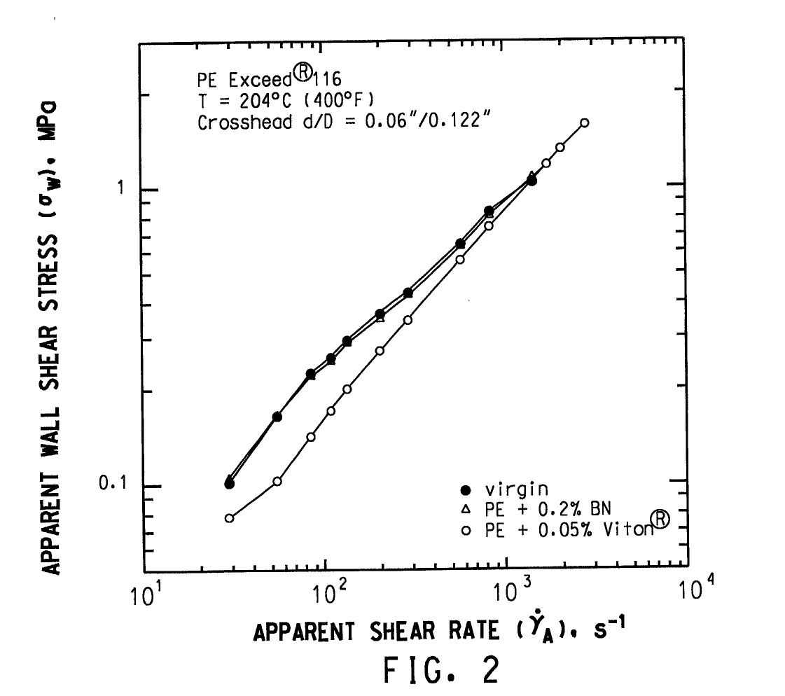

Example 1 shows the separate effects of boron nitride and of Viton® fluoroelastomer on the extrusion of Exceed® 116 metallocene polyethylene at 204° C. Extrusion is done using the capillary rheometer with the crosshead die. The results are summarized in FIG. 2. The curves for virgin polymer with no additive, and the polymer with 0.2 wt. % boron nitride (BN) are nearly coincident. From the curves alone, only a slight beneficial effect of BN can be seen. Inspection of the smoothness of the extrudate surface is necessary to show that BN delays the onset of roughness. Polymer with 0.05 wt. % Viton® fluoroelastomer added lies on a separate curve below the other two when the shear rate is less than 1000 s⁻¹. This shows that with Viton® fluoroelastomer, below 1000 s⁻¹ shear rate, less force is required. This is beneficial in reducing the energy needed for extrusion and verifies that Viton® fluoroelastomer is a useful processing aid, as is well known to those skilled in the art.

### EXAMPLE 2

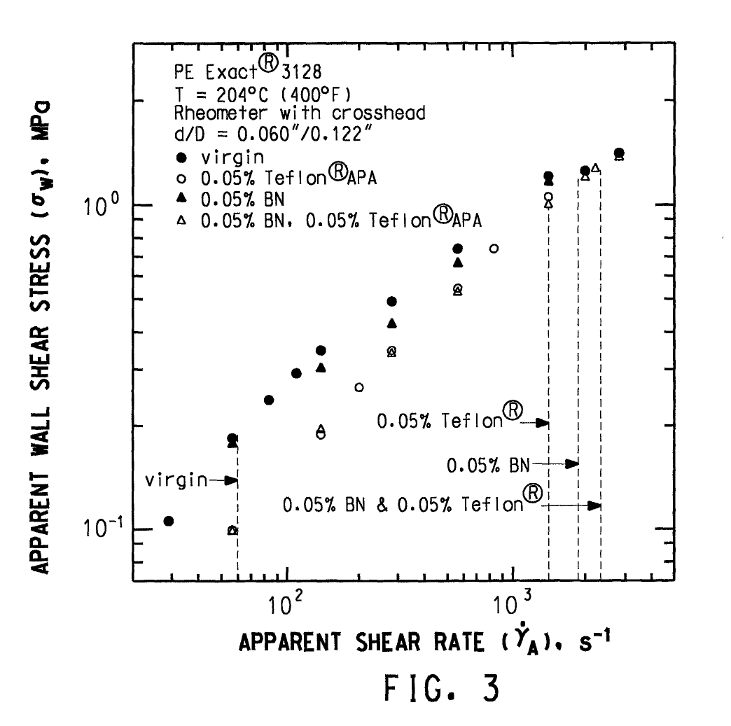

Example 2 shows the extrusion behavior at 204° C. of the metallocene polyethylene Exact® 3128 alone and with BN and fluoropolymer additive separately and combined. FIG. 3 shows four apparent flow curves obtained for the pure resin and those of a blend of Exact® 3128 with 0.05 wt. % of a finely dispersed Teflon® APA-II nonelastomeric processing aid, with 0.05 wt. % BN, and finally with 0.05 wt. % Teflon® APA-II nonelastomeric processing aid and 0.05 wt. % BN combined. The test is run on the crosshead die attached to a capillary rheometer. The onset of melt fracture, i.e. serious deterioration in the condition of the surface, is indicated by the dotted vertical lines. As in Example 1, it can be seen here that the presence of the BN has only a small effect on the flow curve. However, with BN, the critical shear rate is increased from 60 to 1850 s⁻. The Teflon® decreases the shear stress practically over the whole range of apparent shear, and also extends the critical shear rate well beyond that of the virgin resin, though not so far as BN does. The effect of the Teflon® on shear stress diminishes at about the point at which gross melt fracture appears. Surprisingly, in combination, the two additives, Teflon® APA-II nonelastomeric processing aid and BN foam cell nucleating agent, extend the critical shear rate beyond what either achieves alone. The critical shear rate becomes 2250 s⁻¹.

### EXAMPLE 3

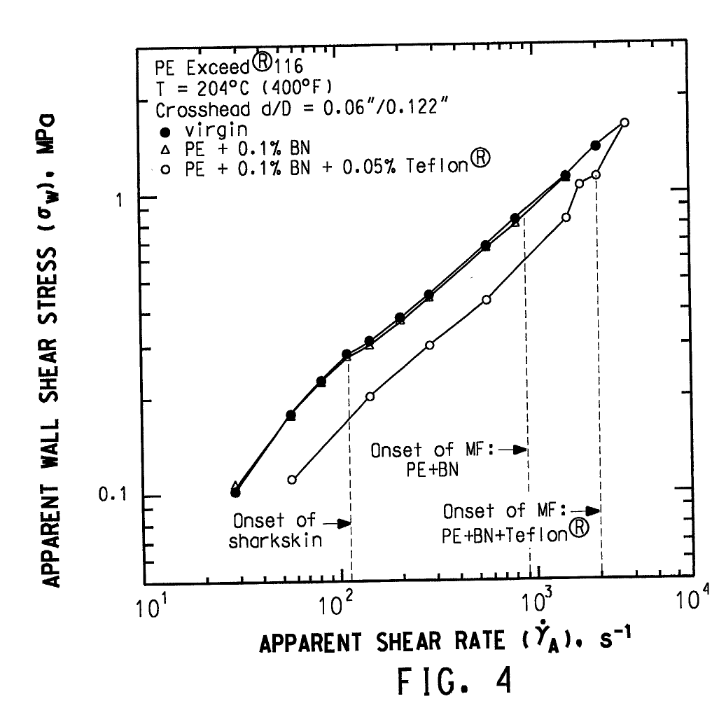

Example 3 shows the extrusion behavior at 204° C. of the metallocene polyethylene Exceed® 116 alone and with the additives of this invention. FIG. 4 shows the flow curves obtained for the pure resin and with 0.1 wt. % BN and 0.1 wt. % BN+0.05 wt. % Teflon® APA-II nonelastomeric processing aid. BN increases the critical shear rate from about 100 s⁻¹ for the virgin resin to almost 1000 s⁻¹. The combined processing aid containing both BN and Teflon® extends the critical shear rate of 2000 s⁻¹. Because shear rate is directly related to extrusion rate, this means that the combined processing aids under these conditions permit a doubling of the extrusion rate, which in commercial use would be a doubling of productivity.

In summary, these examples show that foam cell nucleating agent and fluoropolymer processing aid used separately have beneficial effects on the extrusion of melt processible polymer by extending the critical shear rate beyond that found for the polymer alone. The rheological curves show that the Teflon® also reduces the shear stress. Most surprisingly however, it is found that the combination of foam cell nucleating agent and fluoropolymer processing aid greatly increases the critical shear rate.

### EXAMPLE 4

Example 3 is repeated except that in place of boron nitride, a blend of 800 ppb of BaS-10 and 100 ppb of calcium tetraborate is used. The effect is substantially the same as is seen in Example 3.

What is claimed is:

1. A melt processible composition comprising a melt processible polymer, about 0.001 to about 5 wt. % foam cell nucleating agent, and about 0.001 to about 5 wt. % fluoropolymer processing aid.

2. The melt processible composition of claim 1 wherein the foam cell nucleating agent is present at about 0.001 to about 1 wt. %, and the fluoropolymer processing aid is present at about 0.001 to about 1 wt. %.

3. The composition of claim 1 wherein the melt processible polymer is selected from the group consisting of polyethylene and polypropylene.

4. The composition of claim 1 wherein the melt processible polymer is polyethylene.

5. The composition of claim 1 wherein the melt processible polymer is linear low density polyethylene or linear polyethylene.

6. The composition of claim 1 wherein said foam cell nucleating agent is boron nitride.

7. A shaped article comprised of a melt processible composition comprising melt processible polymer, about 0.001 to about 5 wt. % foam cell nucleating agent, and about 0.001 to about 5 wt. % fluoropolymer processing aid.

8. The shaped article of claim 7 wherein the melt processible polymer is selected from the group consisting of polyethylene and polypropylene.

9. A tube comprised of a melt processible composition comprising melt processible polymer, about 0.001 to about 5 wt. % foam cell nucleating agent, and about 0.001 to about 5 wt. % fluoropolymer processing aid.

10. The tube of claim 8 wherein the melt processible polymer is selected from the group consisting of polyethylene and polypropylene.

11. A coating for a conductor, said coating comprised of a melt processible composition comprising melt processible polymer, 0.001 to 5 wt. % foam cell nucleating agent, and 0.001 to 1 wt. % fluoropolymer processing aid.

12. The coating of claim 11 wherein the melt processible polymer is selected from the group consisting of polyethylene and polypropylene.

13. The process of extrusion of a melt processible composition comprising melt processible polymer, about 0.001 to about 5 wt. % foam cell nucleating agent, and about 0.001 to about 5 wt. % fluoropolymer processing aid.

14. The process of claim 13 wherein the melt processible polymer is selected from the group consisting of polyethylene and polypropylene.
